(19) United States
(12) Patent Application Publication
(10) Pub. No.: US 2018/0180372 A1
(43) Pub. Date: Jun. 28, 2018

(54) HINGE ASSEMBLY WITH RETAINING RING CAM

(71) Applicant: Action Target Inc., Provo, UT (US)

(72) Inventors: Jonathan M. Scott, Spanish Fork, UT (US); Robert DeCosta, Spanish Fork, UT (US)

(21) Appl. No.: 15/851,227

(22) Filed: Dec. 21, 2017

Related U.S. Application Data
(60) Provisional application No. 62/438,368, filed on Dec. 22, 2016.

(51) Int. Cl. F41A 23/02; F41G 11/00; E05F 1/12

(52) U.S. Cl. CPC F41A 23/02; F41G 11/002; E05Y 2600/50; E05Y 2201/638; E05F 1/1269

(57) ABSTRACT

A rifle holder hinge mechanism comprising a rifle hook attached to a hinge block, the hinge block having a hinge block sleeve, with a hinge pin rotatable within the hinge block sleeve. A cam is provided connected to the hinge pin and configured to arrest rotation of the hinge pin, such that the hinge pin is rotatable from a first position to an approximately 90-degree second position. In some configurations, a retaining collar with a first detent and a second detent functions as the rotation limiting cam.

### TECHNICAL FIELD

The present invention relates to a hinge assembly for a rifle support.

### BACKGROUND

In range shooting, shooters often alternate weaponry during shooting practice in an effort to gain proficiency on a variety of weapons, including smaller weapons such as handguns, as well as larger weapons such as rifles. Organization of a plurality of weapons in a small shooting stall can be problematic, particularly with larger weapons that may take up excessive space in a small shooting stall. Accordingly, there is a need to provide structures that assist in organization of weapons and that are unobtrusive and can be minimized during shooting practice.

### SUMMARY OF INVENTION

The present invention relates to a rifle holder hinge mechanism. In one embodiment, the rifle holder hinge mechanisms may comprise a hinge block having a sleeve and mountable to a mounting bracket; a hinge pin rotatable within the hinge block sleeve and comprising a pair of parallel straight grooves on opposing sides of a bottom portion of the hinge pin; a rifle holder hook attached to a top portion of the hinge pin; and a rotation limiting retaining collar having a slot with parallel internal edges configured to non-rotatably slide over the parallel straight grooves of the hinge pin and an asymmetrical external edge that abuts the mounting bracket. The asymmetrical external edge may comprise a first detent configured to engage with the mounting bracket and arrest rotation of the hinge pin at a first position, and a second detent configured to engage with the mounting bracket and arrest rotation of the hinge pin at a second position.

In one embodiment the offset external edge of the retaining collar may be non-circular.

In another embodiment, the external edges of the retaining collar may comprise a 90 degree cam. In another embodiment, the first position and the second position of the hinge pin may be at an angle of about 90 degrees relative to each other.

In another aspect, the offset external edge of the retaining collar may be generally square having a first corner comprising the first detent that abuts the mounting bracket, a second corner rounded to allow rotation of the hinge pin, and a third corner comprising the second detent that abuts the mounting bracket.

In one specific embodiment, the first detent may be configured to engage with the mounting bracket and arrest rotation of the hinge pin at a first position where the rifle holder hook is flush against the mounting bracket and the second detent may be configured to engage with the mounting bracket and arrest rotation of the hinge pin at a second position where the rifle holder hook is positioned outwardly to receive a rifle.

In another particular embodiment, the pair of parallel straight grooves of the hinge pin may be parallel with a direction in which the rifle holder hook extends, such that the retaining collar is mountable over the parallel straight grooves of the hinge pin when the rifle holder hook is positioned flush with the mounting bracket.

In yet another particular embodiment, the slot of the retaining collar may be oriented in the direction of the rifle hook holder such that when the rifle holder hook is positioned outwardly from the mounting bracket the retaining collar is not removable from the hinge pin.

In another aspect, the rifle holder hinge mechanism may comprise a spring mounted in tension between the rifle holder hook and the hinge block to provide a friction fit between the rifle holder hook and the hinge block to prevent free rotation.

### BRIEF DESCRIPTION OF DRAWINGS

The following drawings illustrate what are currently considered to be specific representative configurations for carrying out the invention and are not limiting as to embodiments which may be made in accordance with the present invention. The components in the drawings are not necessarily to scale relative to each other. Like reference numerals designate corresponding parts throughout the several views.

FIG. 1 is an exploded diagram of the single hinge mechanism;

FIG. 2 is a bottom perspective view of the rifle hook support block;

FIG. 3 is a side view of the rifle hook support block;

FIG. 4 is a top perspective view of the hinge block;

FIG. 5 is a side sectional view of the hinge block;

FIG. 6 is a side view of the hinge pin;

FIG. 7 is a perspective view of the cam retaining collar;

FIG. 8 is a perspective view of a rifle holder mounting bracket;

FIG. 9 is a perspective view with two hinge assemblies mounted to the rifle holder mounting bracket;

FIG. 10 is a perspective view of another configuration of a hinge assembly;

FIG. 11 is a perspective view of a hinge assembly mounted to a wall, such as a stall wall;

FIG. 12 is a perspective view of another configuration of a hinge assembly with the pin rigidly attached to the hinge block;

FIG. 13 is a perspective view of another configuration of a hinge assembly;

FIG. 14 is perspective view of yet another configuration of a hinge assembly;

FIG. 15 is a top view of the hinge block of the hinge assembly shown in FIG. 14; and

FIG. 16 is a bottom view of the pin hinge of the hinge assembly shown in FIG. 14.

### DETAILED DESCRIPTION

The following provides a detailed description of particular embodiments of the present invention. Reference will now be made to the drawings in which the various elements of the illustrated configurations will be given numerical designations and in which the invention will be discussed so as to enable one skilled in the art to make and use the invention. It is to be understood that the following description is only exemplary of the principles of the present invention, and should not be viewed as narrowing the scope of the claims which follow, which claims define the full scope of the invention.

The present invention generally relates to a rifle support device having a hinge assembly that allows portions of the support device to be minimized and placed inconspicuously out of the way when not in use. As used herein, the term “rifle” is used to refer to any long weapon, including single shot bolt action rifles, automatic and semi-automatic rifles, shotguns, etc.

The following provides a detailed description of a single hinge assembly. It is understood, however, that two or more hinge assemblies will be used together to provide a plurality, typically two, hinge assemblies mounted together to form two supports for the front and rear of a rifle.

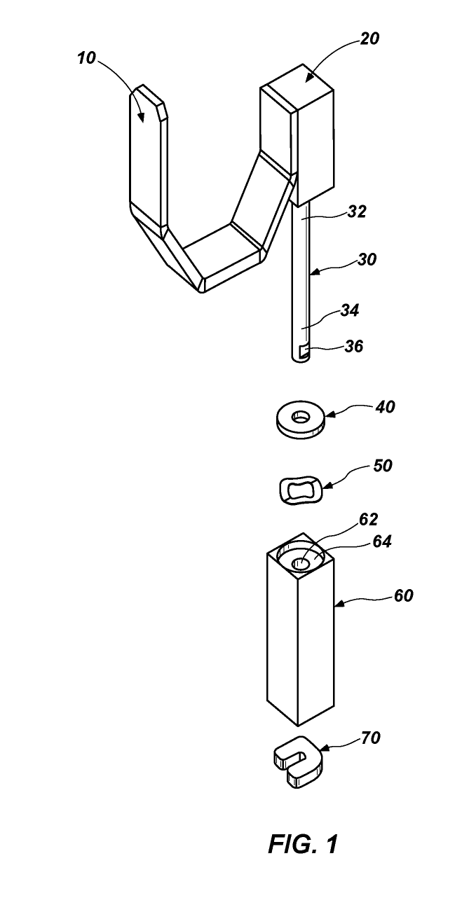

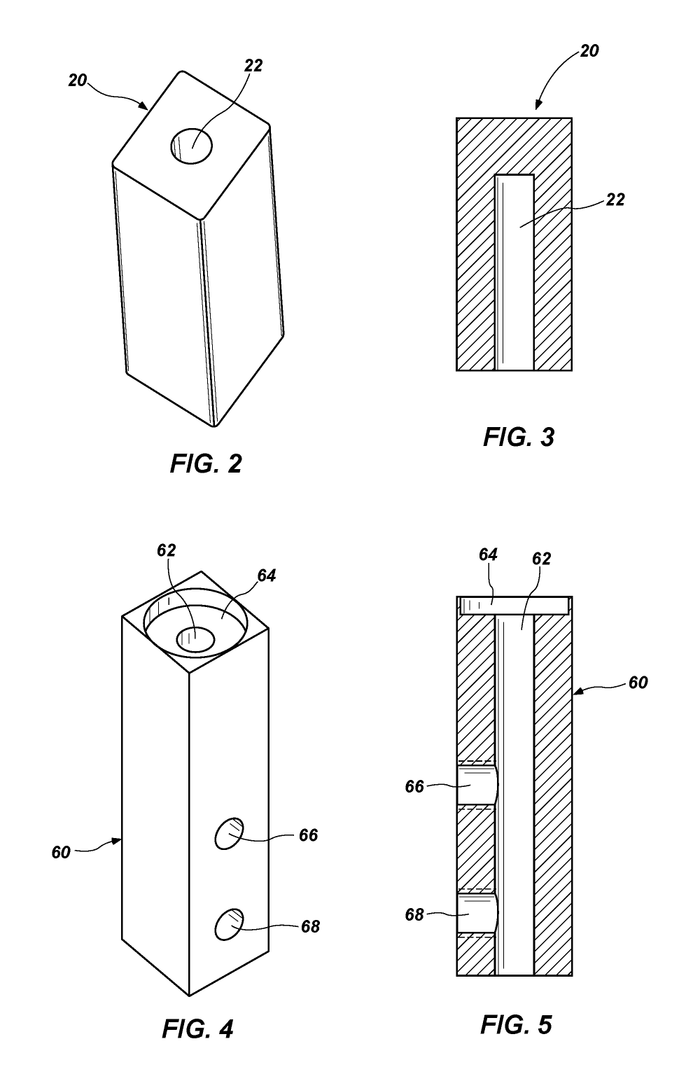

One particular embodiment of the present invention is shown and described in the drawings. FIG. 1 shows an exploded view of a rifle holder hinge assembly. The rifle holder hinge assembly comprises a rifle holder hook 10 attached to a support block 20, to which the top portion 32 of hinge pin 30 is attached. The rifle holder hook 10 may be fixedly mounted to the support block 20 by any suitable means, such as welding, press fitting with a very tight tolerance, etc., or the two parts may be cast or otherwise formed from a single piece of material. FIG. 2 shows a bottom perspective view of the support block 20 with a cylindrical hole 22 in the bottom configured to receive a hinge pin 30 (FIG. 1). FIG. 3 shows a cross sectional view of the support block 20 with the cylindrical hole 22 configured to receive the hinge pin.

FIG. 1 further shows a hinge block 60 having a sleeve 62 which is a cylindrical hole that extends through the entire length of hinge block 60. Sleeve 62 of hinge block 60 is configured to receive and support the hinge pin 30 which is rotatable within the sleeve 62. FIG. 4 shows a top perspective view of the hinge block 60, with the sleeve 62. FIG. 5 shows a cross-sectional view of the hinge block 60. In FIGS. 4 and 5, it can be seen that hinge block 60 may further include a recess 64 configured to receive a washer 40 and disc spring 50 (shown in FIG. 1). The washer 40 may prevent wear on the support block 20. The washer 40 may, for example, be a nylon washer that contributes to smooth rotation. The disc spring 50 further provides tension or pressure between the rifle hook holder support block 20 and the hinge block 60 to provide a friction fit between the rifle hook holder hinge block 60 to prevent free rotation of the hinge pin 30 within sleeve 62. Any other suitable tensioning springs known to those skilled in the art may also be used, such as a standard coil spring, a poly wave spring, a malleable plastic compression spring, etc. It will be appreciated that in some configurations, a washer and a spring may not be provided, or only a spring or only a washer may be provided.

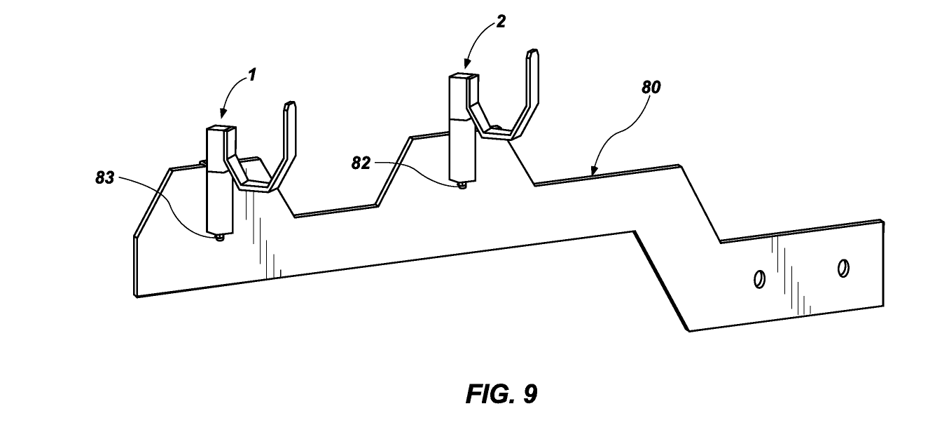

FIGS. 4 and 5 further show mounting holes 66 and 68 for mounting the hinge block 60 to mounting holes 86 and 88 of mounting bracket 80 (shown in FIG. 9) with suitable bolts. For example, mounting holes 66 and 68 may have internal threads to receive a threaded bolt (not shown). The hinge block 60 is mountable to a rifle holder mounting bracket 80, shown separately in FIG. 8 and shown with two hinge assemblies mounted to it in FIG. 9. In some configurations, an additional element such as a retaining ring or circlip or c-clip may also be used to retain the collar 70 in place.

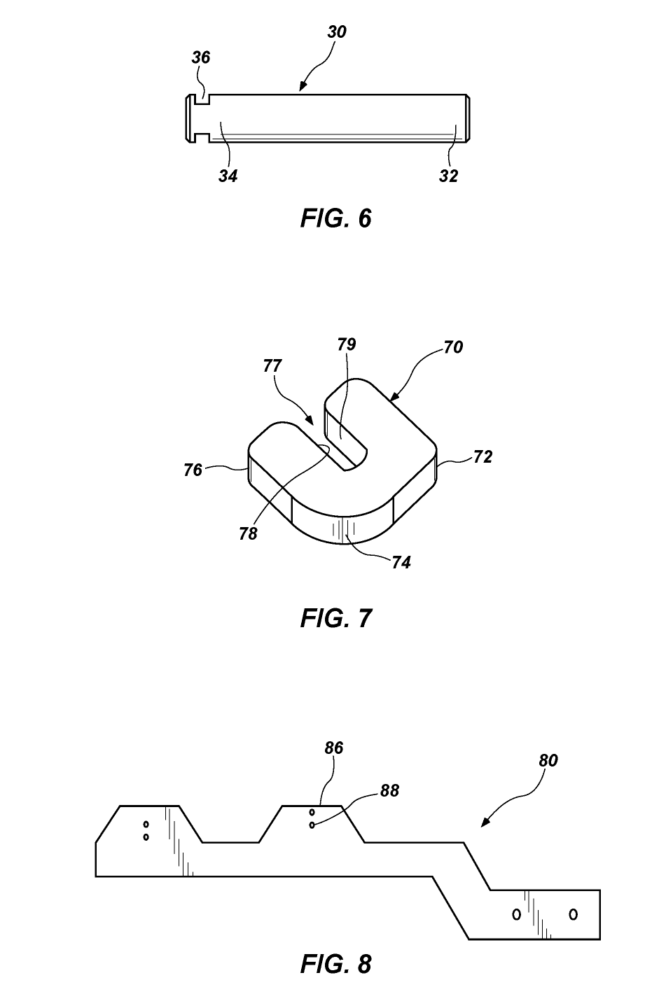

FIGS. 1 and 6 further show hinge pin 30 having a pair of parallel straight grooves 36 on opposing sides of a bottom portion 34 of the hinge pin 30. The parallel straight grooves 36 are configured to receive a retaining collar 70. The parallel straight grooves 36 are also shown in more detail in FIG. 6. It will be appreciated that the pin may have different grooves configured to engage the retaining collar. For example, the pin may have a triangular shape with the retaining collar having an internal triangular diameter to receive the pin. Multiple configurations may be used, such as a triangular engagement, hex engagement, a keyed engagement, a set screw, etc.

FIG. 7 shows details of the retaining collar 70 or cam, which include a slot 77 configured to slide over and mount to the parallel straight grooves 36 on the bottom portion 34 of the hinge pin 30. The slot 77 has parallel internal edges 78 and 79 configured to non-rotatably slide over the parallel straight grooves 36 of the hinge pin 30, and prevent the retaining collar 70 from rotating relative to the hinge pin 30. The retaining collar 70 provides a dual function of retaining the hinge pin 30 within sleeve 62, as well as functioning as a rotation limiting cam, as explained below. The internal edges of the retaining collar 70 may also be any suitable size and shape to engage the pin (such as the triangular engagement, hex engagement, etc. as described above).

As shown in more detail in FIG. 7, the retaining collar 70 has an asymmetrical external edge that enables the retaining collar 70 to also function as a stop cam. The external edge of the retaining collar 70 shown in FIG. 7 is non-circular and asymmetrical. When the hinge block 60 is mounted to the mounting bracket 80, the external edge abuts the mounting bracket when the hinge pin 30 rotates. The asymmetrical external edge of retaining collar 70 comprises a first detent, shown as corner 72, which is configured to engage with the mounting bracket 80 (shown in FIG. 8) and arrest rotation of the hinge pin at a first position. The asymmetrical external edge of retaining collar 70 further comprises a second detent, shown in corner 76, which is configured to engage with the mounting bracket 80 and arrest rotation of the hinge pin at a second position. Thus, in the embodiment shown in the drawings, the offset external edge of the retaining collar is generally square having a first corner comprising the first detent 72 that abuts the mounting bracket 80, a second corner 74 rounded to allow rotation of the hinge pin, and a third corner comprising the second detent 76 that abuts the mounting bracket 80. Corner 74 is rounded such that when the retaining collar 70 is rotated, rounded corner 74 does not impact the mounting bracket 80 to which the hinge block 60 is mounted and rounded corner 74 does not arrest rotation of the hinge pin 30.

In one embodiment of the present invention, the first detent 72 and second detent 76 are positioned on the external edge of the retaining collar such that the external edge comprises a 90-degree cam. For example, the first detent 72 and second detent 76 are positioned such that the first position and the second position of the hinge pin are at an angle generally of about 90 degrees relative to each other.

In another aspect of the invention, the first detent 72 of retaining collar 70 is configured to engage with the mounting bracket 80 and arrest rotation of the hinge pin at a first position where the rifle holder hook is flush against the support bracket and the second detent 76 of retaining collar 70 is configured to engage with the mounting bracket 80 and arrest rotation of the hinge pin at a second position where the rifle holder hook is positioned outwardly to receive a rifle. This configuration is generally accomplished by orienting the hinge pin 30 in the proper orientation relative to the rifle holder hook 10, as shown in FIG. 1.

In another aspect of the invention, the pair of parallel straight grooves 36 of the hinge pin 30 may be oriented to be parallel with the direction in which the rifle holder hook extends, such that the retaining collar 70 is mountable over the parallel straight grooves 36 of the hinge pin 30 when the rifle holder hook is positioned flush with the support bracket.

In yet another aspect of the invention, the slot 77 of the retaining collar 70 is oriented in the direction of the rifle hook holder 10 such that when the rifle holder hook 10 is positioned outwardly from the support bracket the retaining collar 70 is not removable from the hinge pin.

FIG. 8 shows one embodiment of a suitable mounting bracket 80, having holes 86 and 88 corresponding to threaded mounting holes 66 and 68 of the hinge block 60 used to mount the hinge block 60 to the mounting bracket 80 via threaded bolts (not shown). In some configurations, the assembly may be mounted directly to a shooting stall without the use of a bracket.

FIG. 9 shows two hinge mechanisms 1 and 2, mounted to a mounting bracket 80. The mounting bracket 80 forms a backstop 82 and 83 behind the mounted hinge mechanisms. As described above, the retaining collar 70 has a first detent 72 that is configured to engage with the back 82 of mounting bracket 80 when it is turned in one direction, so as to arrest rotation of the hinge pin at a first position where the rifle holder hook is flush against the support bracket. The second detent 76 of retaining collar 70 is also configured to engage with the back 83 of mounting bracket 80 when it is turned in the opposite direction, so as to arrest rotation of the hinge pin at a second position where the rifle holder hook is positioned outwardly to receive a rifle.

In accordance with the above disclosure, when oriented properly the cam allows for 90 degrees of rotation and prevents disassembly from all but one position (completely closed). The 90-degree cam doubles as a retaining ring, keeping the entire assembly together. The cam is also designed to be the failure point if the hook is stressed beyond its limits. If it fails it will fail in a way that can be repaired by replacing the cam.

Many other configurations for the rifle holder hinge assembly are contemplated. For example, the cam or retaining collar may contact another portion of the hinge assembly (besides the bracket) to limit rotation of the hinge mechanism(s) relative to the mounting bracket or may engage a flange on the hinge block 60. Similarly, the cam need not be located below the hinge block, but may be incorporated at another location, such as above the hinge block.

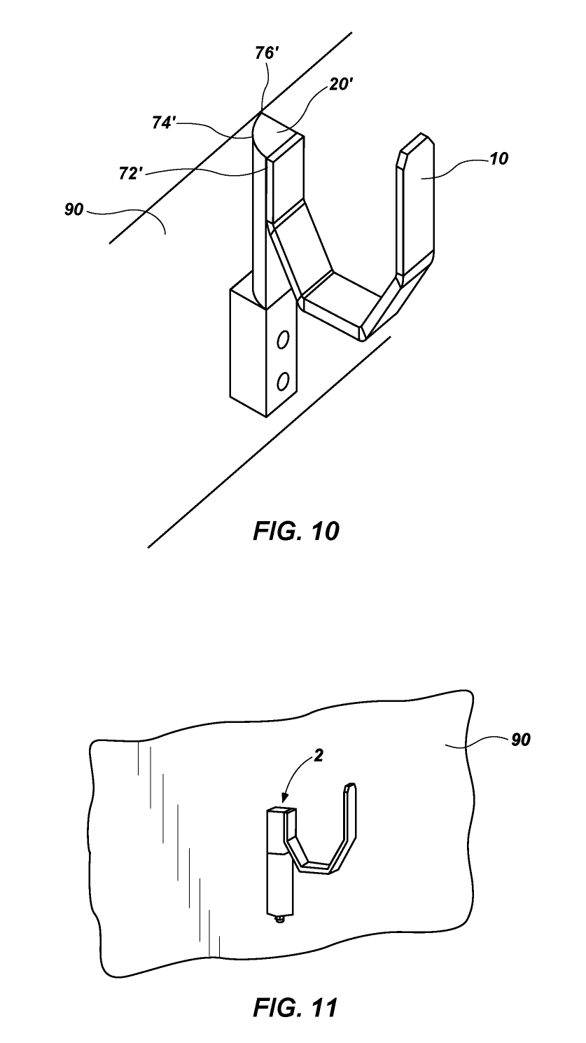

In one configuration, the support block 20′ may form a cam. In FIG. 10, support block 20′ forms a cam to limit rotation of the support block. In such a configuration, the offset external edge of the support block 20′ forming the cam is generally square having a first corner comprising the first detent 72′ that abuts the mounting bracket 80, a second corner 74′ rounded to allow rotation of the support block 20′, and a third corner comprising the second detent 76′ that abuts the mounting bracket 80. Corner 74′ is rounded such that when the support block 20′ is rotated, rounded corner 74′ does not impact the mounting bracket 80 to which the hinge block 60 is mounted and rounded corner 74′ does not arrest rotation of the support block 20′.

In the embodiment shown in FIG. 10, the first detent 72′ and second detent 76′ are positioned on the external edge of the support block 20′ such that the external edge comprises a 90-degree cam. For example, the first detent 72′ and second detent 76′ are positioned such that the first position and the second position of the support block 20′ are at an angle generally of about 90 degrees relative to each other.

FIG. 11 shows an alternate embodiment with the hinge mechanism 2 directly mounted onto a wall 90, such as the wall of a shooting stall, instead of mounted to a mounting bracket.

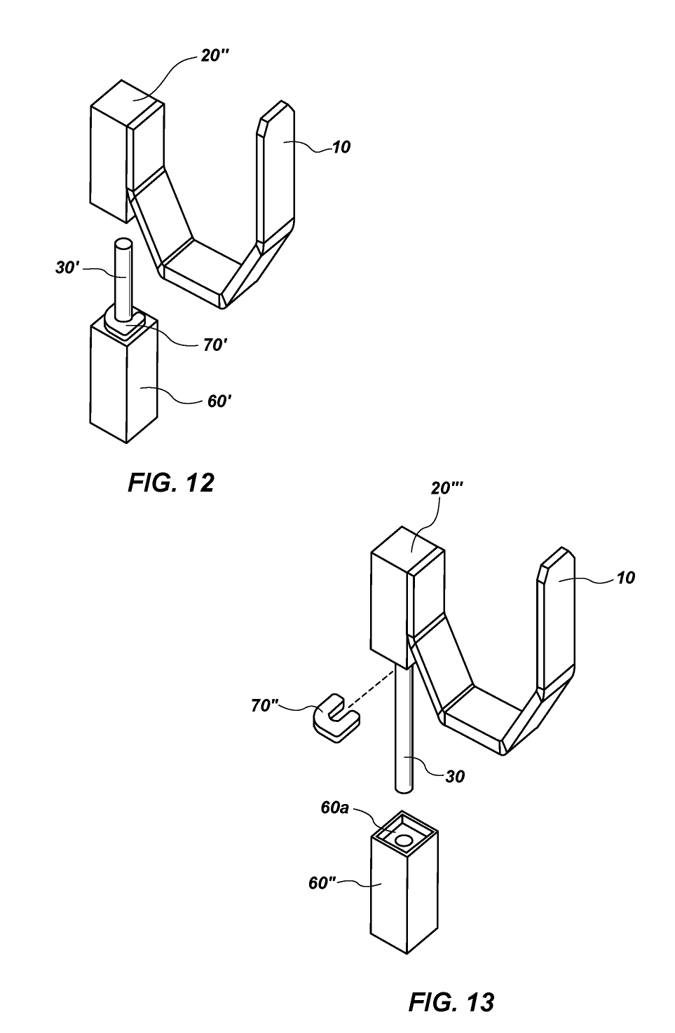

Various other alternate configurations of the hinge assembly are contemplated. For example, FIG. 12 shows a perspective view of a pin hinge assembly wherein the pin hinge 30′ may be rigidly attached to the hinge block 60′. The cam or retaining collar 70′ may be attached to the pin hinge 30′. The support block 20″ may have a pocket or other geometry to limit rotation of the retaining collar 70′.

In yet another configuration of the hinge assembly, a perspective view of which is shown in FIG. 13, the hinge block 60″ may comprise a pocket 60a near the top end. The retaining collar 70″ may be inserted on the hinge pin 30 and nest inside pocket 60a. The retaining collar 70″ may interact with pocket 60a on hinge block 60″ to limit rotation of the support block 20″' relative to the hinge block 60″.

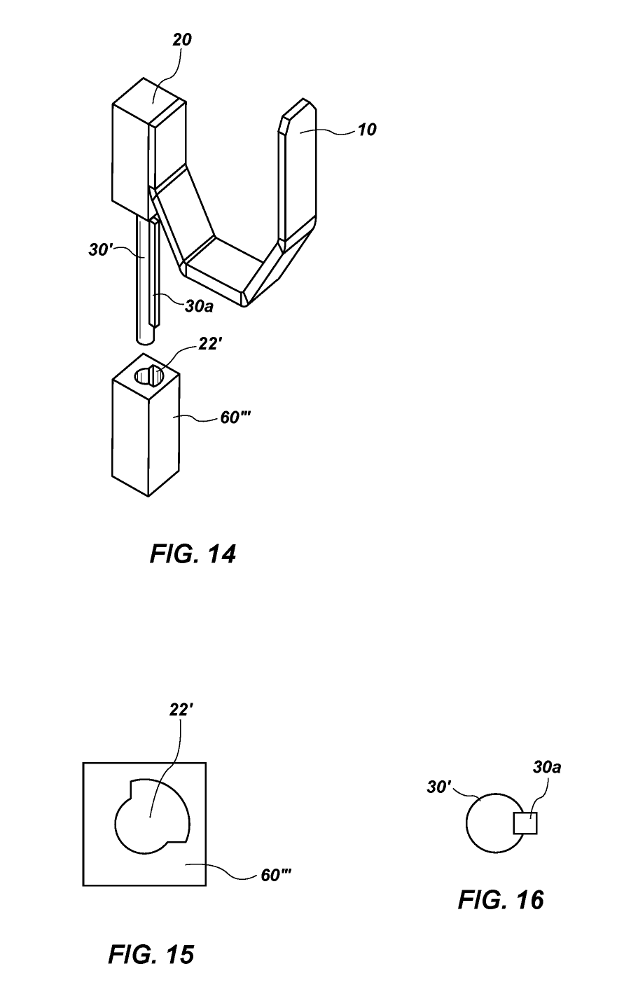

According to another configuration, shown in FIGS. 14-16, the cam may also be incorporated internally to the hinge block, and limit rotation of the hinge pin within the hinge block. The functionality of the cam may be integral to the pin to limit rotation of the pin within the sleeve, such as with a cam pin. In this configuration, the hinge block 60′″ may have a hole 22′ that includes an approximately 90 degree cut-out to engage a hinge pin 30′ having a complementary keyed portion 30a. FIG. 14 shows a perspective view of this configuration. FIG. 15 shows a top view of the hinge block 60′″ of the hinge assembly shown in FIG. 14, showing one possible geometry for the hole 22′. FIG. 16 shows a bottom view of the pin hinge 30′ of the hinge assembly shown in FIG. 14, with the keyed portion 30a.

While the invention has been described in particular with reference to certain illustrated configurations, such is not intended to limit the scope of the invention. The present invention may be embodied in other specific forms without departing from its spirit or essential characteristics. The described configurations are to be considered as illustrative and not restrictive. The scope of the invention is, therefore, indicated by the appended claims rather than by the foregoing description. All changes which come within the meaning and range of equivalency of the claims are to be embraced within their scope.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A rifle holder hinge mechanism, comprising:
a hinge block having a hinge block sleeve, and a rifle holder hook attached thereto;
a hinge pin rotatable within the hinge block sleeve; and
a cam connected to the hinge pin comprising a first detent to arrest rotation of the hinge pin at a first position and a second detent to arrest rotation of the hinge pin at a second position.

2. The rifle holder hinge mechanism of claim 1, wherein the cam is connected to the hinge pin internal to the hinge block.

3. The rifle holder hinge mechanism of claim 1, wherein the cam is connected to the hinge pin external to the hinge block.

4. The rifle holder hinge mechanism of claim 1, wherein the hinge pin comprises grooves on a bottom portion of the hinge pin; and wherein the cam comprises a retaining collar having a slot with internal edges configured to non-rotatably slide over the grooves of the hinge pin and an asymmetrical external edge that abuts a mounting surface.

5. The rifle holder hinge mechanism of claim 4, wherein the asymmetrical external edge comprises the first detent configured to engage with a mounting surface and arrest rotation of the hinge pin at the first position, and the second detent configured to engage with the mounting surface and arrest rotation of the hinge pin at the second position.

6. The rifle holder hinge mechanism of claim 4, wherein the mounting surface comprises a wall.

7. The rifle holder hinge mechanism of claim 4, wherein the mounting surface comprises a mounting bracket.

8. The rifle holder hinge mechanism of claim 4, wherein the grooves on a bottom portion of the hinge pin comprise parallel straight grooves on opposing sides of a bottom portion of the hinge pin; and wherein the internal edges of the slot of the cam comprise parallel internal edges configured to non-rotatably slide over the parallel straight grooves of the hinge pin.

9. The rifle holder hinge mechanism of claim 1, wherein the hinge pin is rigidly mounted to a mounting surface.

10. A rifle holder hinge mechanism, comprising:
a hinge block having a hinge block sleeve;
a hinge pin rotatable within the hinge block sleeve and comprising at least one groove on a bottom portion of the hinge pin;
a rifle holder hook attached to a top portion of the hinge pin;
a retaining collar having a slot with at least one complementary internal edge configured to non-rotatably slide over the at least one groove of the hinge pin and an asymmetrical external edge that abuts a mounting surface, wherein the asymmetrical external edge comprises
a first detent configured to engage with a mounting bracket and arrest rotation of the hinge pin at a first position, and
a second detent configured to engage with the mounting bracket and arrest rotation of the hinge pin at a second position.

11. The hinge mechanism of claim 10, wherein the asymmetrical external edge of the retaining collar is non-circular.

12. The hinge mechanism of claim 10, wherein the external edges of the retaining collar comprise a 90 degree cam.

13. The hinge mechanism of claim 10, wherein the first position and the second position of the hinge pin are at an angle of about 90 degrees relative to each other.

14. The hinge mechanism of claim 10, wherein the offset external edge of the retaining collar is generally square having a first corner comprising the first detent that abuts the mounting bracket, a second corner rounded to allow rotation of the hinge pin, and a third corner comprising the second detent that abuts the mounting bracket.

15. The hinge mechanism of claim 10, wherein the first detent is configured to engage with the mounting bracket and arrest rotation of the hinge pin at the first position where the rifle holder hook is flush against the mounting bracket and the second detent is configured to engage with the mounting bracket and arrest rotation of the hinge pin at the second position where the rifle holder hook is positioned outwardly to receive a rifle.

16. The hinge mechanism of claim 10, wherein the pair of parallel straight grooves of the hinge pin are parallel with a direction in which the rifle holder hook extends, such that the retaining collar is mountable over the parallel straight grooves of the hinge pin when the rifle holder hook is positioned flush with the mounting bracket.

17. The hinge mechanism of claim 11, wherein the slot of the retaining collar is oriented relative to a direction of the rifle holder hook such that when the rifle holder hook is positioned outwardly from the mounting bracket the retaining collar is not removable from the hinge pin.

18. The hinge mechanism of claim 10, further comprising a spring mounted in tension between the rifle holder hook and the hinge block to provide a friction fit between the rifle holder hook and the hinge block to prevent free rotation.

19. The hinge mechanism of claim 10, wherein the mounting surface comprises a mounting bracket.

20. The rifle holder hinge mechanism of claim 1, wherein the rifle holder hook is attached to a support block, the support block forming a cam.
